(19) United States
(12) Patent Application Publication
(10) Pub. No.: US 2016/0019579 A1
(43) Pub. Date: Jan. 21, 2016

(54) SYSTEMS AND METHODS TO COORDINATE COMMUNICATION PROGRAMS

(71) Applicants: Jamie Reardon Sims, Scottsdale, AZ (US); Cristine Vieira, Scottsdale, AZ (US)

(72) Inventors: Jamie Reardon Sims, Scottsdale, AZ (US); Cristine Vieira, Scottsdale, AZ (US)

(21) Appl. No.: 14/714,130

(22) Filed: May 15, 2015

Related U.S. Application Data
(60) Provisional application No. 62/001,492, filed on May 21, 2014.

(51) Int. Cl. G06Q 30/02; G06Q 50/00

(52) U.S. Cl. CPC G06Q 30/0242; G06Q 50/01

(57) ABSTRACT

The invention is a system and method for coordination communication between an advertiser, an influencer and consumers in connection with an influencer campaign which uses social media. The invention also provides a method and system for evaluating the effectiveness of an influencer campaign as well as individual influences who participate in an influencer campaign. The invention gathers and stores social media data which is, in turn, used to evaluate how well and influencer campaign has reached consumers. The invention also measures the reach of individual influencers.

### RELATED APPLICATIONS

This application claims priority to U.S. Provisional application Ser. No. 62/001,492 filed May 21,2014, entitled Systems and Methods to Coordinate Communication Programs.

Influencer marketing is a form of marketing that has emerged from a variety of recent practices and studies, in which focus is placed on specific key individuals (or types of individual) rather than the target market as a whole. It identifies the individuals that have influence over potential buyers or consumers, and orients marketing activities around these influencers.

Influencers may be potential buyers or consumers themselves, or they may be third parties. These third parties exist either in the supply chain (retailers, manufacturers, etc.) or may be so-called value-added influencers (such as journalists, academics, industry analysts, professional advisers, and so on).

A decade ago, companies began to recognize the growth and influence blogs had on the general consumer. Companies such as WordPress, Technorati, and AdSense were organized to increase blog exposure and enable advertisers to connect with influencers. As blogs became more established and even institutionalized, conferences such as BlogHer and BlogWorld were created to connect influencers and brand sponsors. In 2012, 81% of U.S. online consumers' purchase decisions were influenced by their friends' social media posts. Currently, 329 million people read blogs and blogs are giving sites 434% more indexed pages.

Over the last two years, influencer marketing has become common practice among marketers, with 65% of Brands participating in influencer campaigns. Many agencies have taken the opportunity to service their clients by helping with campaign management and support but the tedious task of connecting with the right influencers, launching and managing campaigns, tracking results across social media channels and blogs as well as managing payments with influencers remains.

A brand may also build its own influencer campaign by reviewing influencer directories and contacting them directly. This exercise generally takes significant time to recruit and gain the trust of the right influencers. Additionally, this requires an individual to manage the content distribution and payment, as well as have access to a reporting platform that tracks program performance. Due to the fragmented and unorganized nature of this market, it is difficult for advertisers to efficiently reach a diversified base of bloggers and effectively influence consumers purchase decisions.

The fragmented and unorganized nature of the social media market also makes it difficult to determine the effectiveness of the campaign as well as the effectiveness of individual influences. As a result there is a need for a system and method that allows advertisers to reach a diversified and effected base of on-line influencers and to determine the effectiveness of their campaigns.

### SUMMARY OF THE INVENTION

The invention relates to a method and system to facilitate and coordinate communication between advertisers and on-line social media influencers throughout all phases of influencer campaigns which use blogs or social media to reach, consumers. The invention involves the creation database of influencers who use electronic and/or social media to reach consumers. The influencers are then evaluated to determine their effectiveness and assigned a rating. The effectiveness of the influence campaign can also be gaged.

Using the system of the invention, advertisers develop an advertising plan to distribute information about their products and/or services to consumers using blogs or social media. Using the information provided by the advertiser, the system identities potential influencers who can help the advertiser implement the influencer campaign.

The invention then allows the advertiser to select those influencers that best fit its needs and to then contact them, to engage the influencers. Once the influencer is hired by the advertiser, the influencer is assigned a unique identifier for the campaign. The identifier allows the system to track the posts created by the influencer for a given influencer campaign. The data is then used as part of the rating system for the influencer and for generating reports on the effectiveness of a given influencer campaign.

The influencer includes the unique identifier in all communications it generates as part of the campaign (posts). This ensures that the influencer is following FTC requirements by disclosing that they are being paid by the advertiser and allows the system to track the effectiveness on the influencer's communications.

The system gathers social media data such as Social Reach and Social Engagement data for both the influencer campaign and the influencer. Social media data may include, but is not limited to such elements as the number of consumers who access an influencer's communication, and “likes” that are registers for a communication, the number of comments entered by consumers and the number of times the information is shared by the consumer. The information is stored in a database and analyzed to determine the effectiveness of the influencer campaign and whether the influencer has performed as agreed. The advertiser has access to periodic or on-demand reports about the status of the campaign based on the information and analyses obtained through the use of the unique identifier.

Once the campaign has ended, the system allows for billing for the influencer's activity and payment for those activities to the influencer.

The invention also facilitates the negotiation and formation of a contract between the advertiser and the influencer setting forth, such details as the nature of the influencer campaign, the compensation paid to the influencer and the duration of the campaign.

### BRIEF DESCRIPTION OF THE DRAWINGS

FIG. 1 is flow diagram showing the method of the invention

FIG. 2 is a flow diagram showing an advertiser's interaction with the system of the invention.

FIG. 3 is a flow diagram showing an influencer's interaction with the system of the invention

FIG. 4 is a screen shot of the campaign criteria page of the system of the invention.

FIG. 5 is a screen shot showing an example of the search criteria used to identify potential influencers.

FIG. 6 is a screen shot of a page showing the criteria to he entered by an advertiser to outline an influencer campaign.

FIG. 7 is a screen shot of a page used by an advertiser to generate an offer to an influencer.

FIG. 8 is a screen shot of a typical report generated by the system for an influencer campaign.

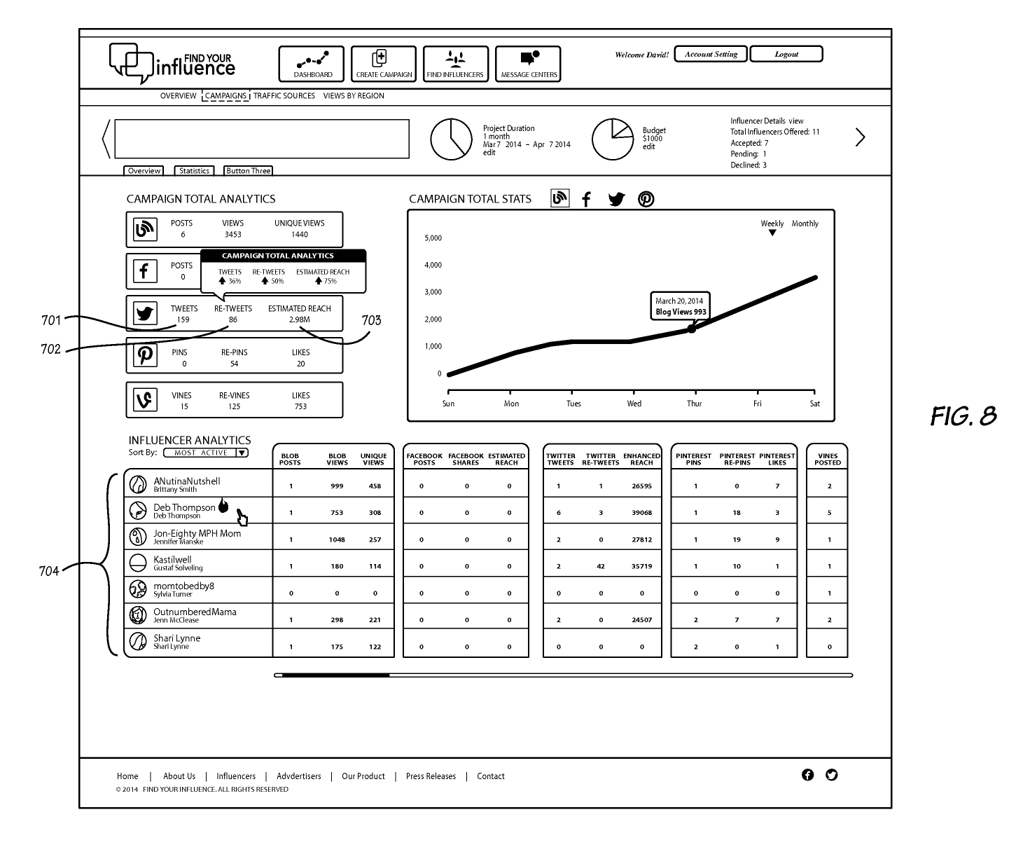

### DETAILED DESCRIPTION OF THE INVENTION

The invention is a system and method for coordinating communications as part of an influencer marketing campaign. The invention allows advertisers to develop an influencer campaign and men engage and track the activity of established influencers.

The invention also comprises a method for determining the effectiveness of influencer campaigns as well as the effectiveness of individual campaigns.

The systems uses a database of established influencers who use blogs and/or social, media to influence consumers' decisions as to whether to buy or use certain goods or services. The database is created by having potential influencers enter information concerning their social media activity such as the types of social media they use and the typical number of followers they have for each type of social media used. This data is augmented and supplemented with data collected by the system as described below.

Once the influencer has entered the required information into the database, the system rates the influencer and makes the influencer information available to advertisers. In one embodiment the system of the invention gathers information in several areas of interest such as Social Reach; Engagement; Response Time; Quality of Data; Recommendations and Ratings; Social Engagement as well as other metrics that relate to the influencer's effectiveness.

Social Reach is determined by the extent the influencer is engaged in various social media including, for example, the number of followers on Twitter and/or Instagram; the number of Facebook followers and the like

Engagement refers to the influencer's involvement with advertisers and includes such data as the number of visits by advertisers to the influencer's account the time spent with advertisers, percentage of engagements on social channels as well as campaign engagement performance.

Response time refers to how long it takes an influencer to respond to request either from an advertiser or from the system.

Qualify of Data is based on the data reported by an influencer with respect to his social media reach with the data actually measured by the system.

Recommendations and Ratings are derived from system measurements of the influencer's quality of participation as well as ratings mid recommendations received from individual advertisers.

Social Engagement is calculated based on the social engagement of the influencer's followers using such data as number of likes, comments, shares and retweets.

Other factors included in the influencer's rating include Number of campaigns, offered, acceptance ratio, completion percentage and negotiations.

Data in each of the above categories is collected on a periodic basis, typically on a daily basis and the influencer's rating is then recalculated. The rating is calculated as a relative number of the absolute value. For example, if an influencer doesn't have a value in one or more of the categories listed above, the score is calculated based on the categories, where data is present.

Each category is given a weightage in the calculation of the rating. For example the system has gathered the following data regarding an influencer: Star rating of 4 out of 5 (which, is converted to 0.8 based on a weight factor of 10). Social Reach rating of 12 (based on all values for each social media number) on a scale of 1 to 20; Engagement 1 (new user) (weighted scale of 0/0); and Social Engagement of 4 out of 10. Assuming there is no other data available the influencer's rating is calculated as follows: ((8+12+4)/(10+20+10))*100=60.

Those skilled in the art will understand that the rating categories discussed above as well as the rating values assigned to each category are illustrative and that other criteria and values can be used without departing from the spirit and scope of the invention.

The resulting score is then posted on the influencer s profile within the system for advertisers to see. In one embodiment, the score is also used to set the compensation of the influencer for campaigns executed through the system.

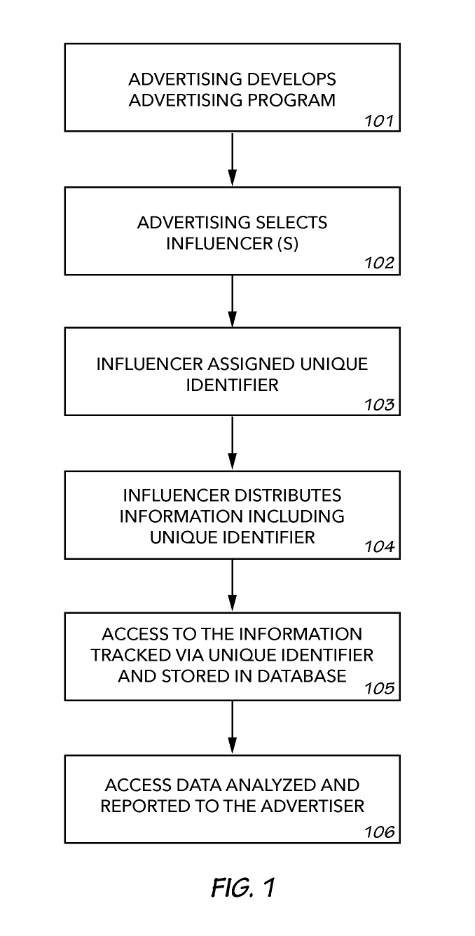

Referring now to FIG. 1, a schematic of the system of the invention is shown. At the step shown in box 101, the advertiser develops an influencer marketing or advertising campaign. The campaign includes such information as the type of media that will be used in the campaign, the nature of the product or service that will be the subject of the campaign, specifications as to the type of influencers to be used in the campaign and how the campaign is to be executed

Once the advertiser has entered the campaign criteria into the system, the system then generates a list of potential influencers that meet the advertiser's criteria.

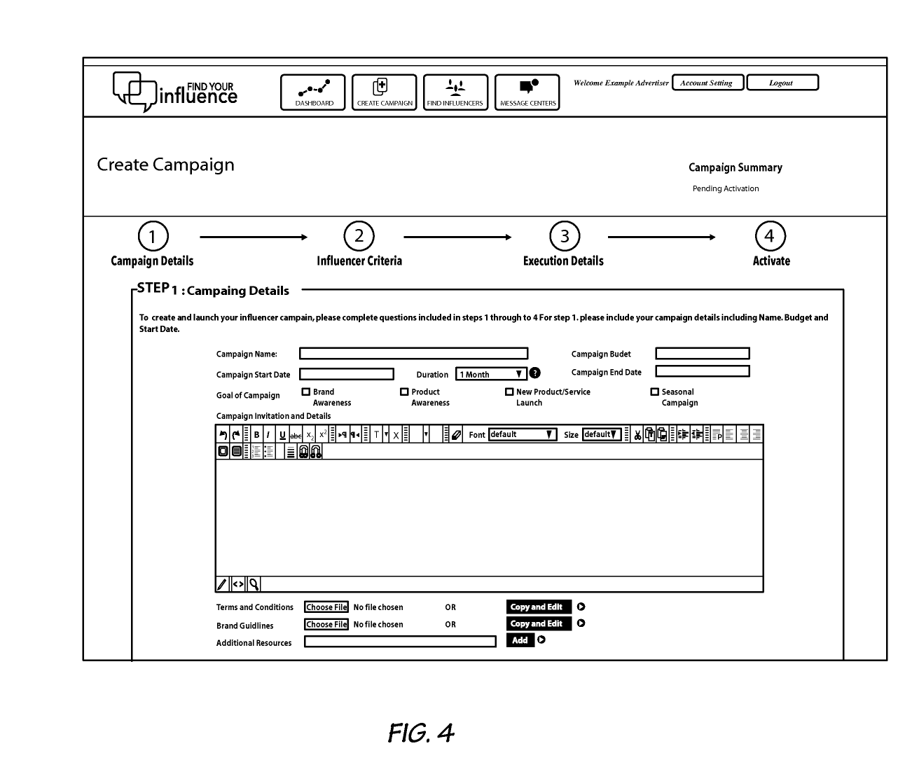

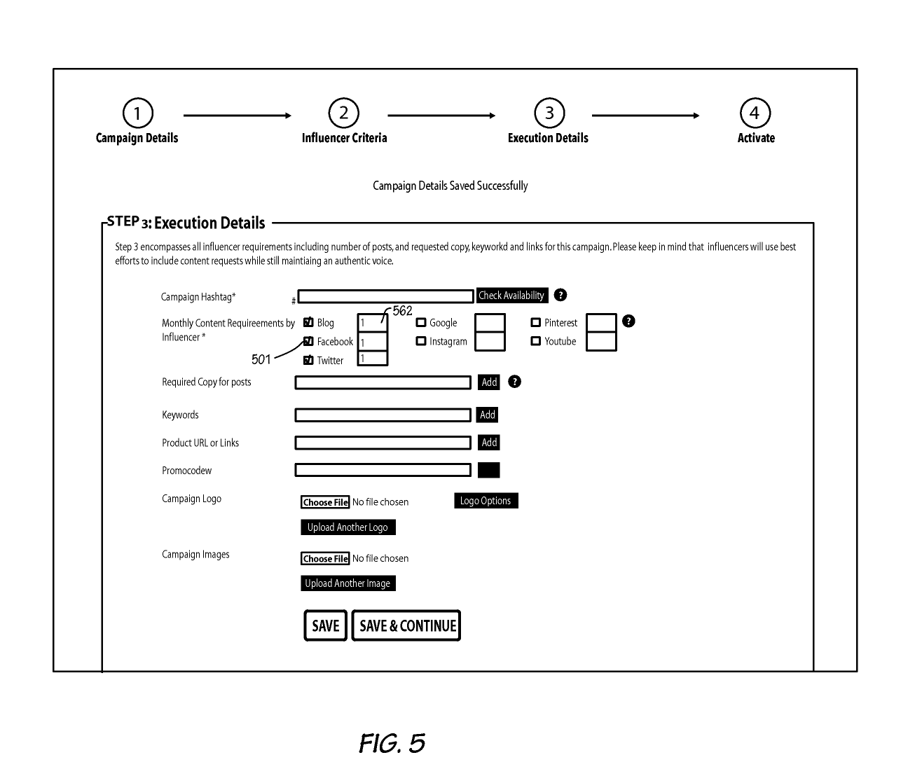

In one embodiment, the system uses historic and real-time data collected on influencers as well as the influencer rating described above to create a list of influencers that meet the advertiser's criteria. First the advertiser enters the criteria for the influencer campaign and the type of influencer the advertiser would like to use for the campaign. As shown in FIGS. 4 and 5, typical campaign and influencer information includes, but is not limited to, the number of Facebook posts needed, 501, and the expected reach, 601; Number of Blog views, 502, and number of posts needed, geographic requirements, 602, and demographics. This criteria is then compared with the data contained in the influencer database. The comparison is made using such influencer information as the influencer rating discussed above; quality metrics such as star ratings from other advertisers; engagements and verified statistics.

Once the system has generated a pool of potential influencers it further refines the search and assigns values to each influencer in the pool based on how well they match the criteria set forth by the advertiser. In one embodiment the following criteria are used; Work with the Advertiser Before; Quality of Data; System Recommendation; Category Strength; Response Time; and Other Criteria.

Worked With Advertiser Before refers to the number of times the influencer has worked with a given advertiser before and the star rating the advertiser has given the influencer in the past. This is assigned a score of 1 to 10.

Quality of Data refers to the average quality index for an influencer in prior campaigns and is based in such criteria as verified statistics, no-spam counts and the like. Thus is again assigned a score of 1 to 10.

System Recommendation is based on how well the influencer has performed in prior engagements and is a rating of 1 to 10.

Category Strength is a comparison of the categories addressed, by influencers with those working in categories that more closely align with the proposed campaign receiving a higher score. In this embodiment the rating is on a scale from 1 to 5.

Response Time is a measure of how quickly influencers respond to communications from the advertiser or the system. In this embodiment, the influencers receive a rating of from 1 to 5 with the higher rating representing a quicker average response time.

Other criteria can include such information as an influencer's favorite count how long the influencer has used the system and the completeness ad currency of the influencer's profile. In this embodiment, the rating ranges from 1 to 10.

Using the values generated above each influencer is assigned a value of from 1 to 50. The percent value is then calculated based on the value and number of criteria matched. For example, and influencer might have a Worked With rating of 8, a Quality of Data rating of 7, a System Recommendation of 0, a Category Strength of 4, a Response Time of 3 and an Other rating of 7. The match index can then be calculated as follows: ((8+7+0+4+3+7)/(10+10+0+5+5+10))*100=72.5.

Those skilled in the art will appreciate that the categories and rating values listed above are illustrative and that other rating categories and rating values can be sued without departing from the spirit and scope of the invention.

The list includes information about the influencers based on the information that was pulled into the database as well as the influencer rating discussed above. The list of influencers is then made available to the advertiser.

In the next step, 102, the advertiser selects one or more influencers to execute the influencer campaign. The advertiser contacts the influencer via the system which offers the influencer a contract to carry out the proposed campaign. The system permits the advertiser and the influencer to negotiate the terms under which the influencer will carry out the campaign and the metrics that will be used to determine if the campaign is successful. The advertiser and the influencer also discuss the content of the communications to be created by the influencer as well, as the frequency of the communications.

In step 103, once the influencer and advertiser have agreed on the details of the campaign, the influencer is assigned a unique identifier for the campaign. For example, in one embodiment, the identifier takes the form of a badge like icon that is unique to the influencer and the campaign. The influencer is then assigned a unique identifier generated by the system that identifies the influencer and the specific influencer campaign. In one embodiment, the identifier comprises and tracking icon and a tracking link. In addition the system also generates images for each influencer to be used during the course of the influencer campaign.

The identifier serves several purposes. When included in the communication published, by the influencer, if informs the consumer that the influencer is being paid to distribute the information contained in the communication, fulfilling the disclosure requirements of the Federal Trade Commission. The identifier is also design to facilitate the tracking and effectiveness of the communication.

The influencer then distributes information about the advertisers product or service using blogs or social media, 104. The information is distributed in the form of blogs, posts or tweets using such media as Facebook, Twitter, Instagram, Pinterest and the like. Included in the information posted by the influencer is the unique identifier described above.

Once the influencer has distributed the information. The system, using the identifier, tracks the effectiveness of the campaign, step 105. This is accomplished by using the system generated identifier to locate the blogs or posts relating to a specific campaign and/or influencer and then gathering such social media data as Social Reach and Social Engagement data with respect to that post or blog. For example. Facebook keeps a tally of likes, comments and shares as well as the number if original views. This information composes social media data and is gathered by the system relative to each post using the identifier generated by the system.

In one embodiment the system searches different social media on a periodic basis to locate the posts or blogs that contain the system generated identifiers. When the posts or blogs are located the system gathers social media data relating to the post or blog and adds the social media data to the influencer and campaign databases.

In yet another embodiment the system connects with the link embedded within the identifier and then gathers the Social Reach and Social Engagement data associated with that link. The identifier can be a .NET web script, that is used to collect all HTTP variable supplied by a browser when a page is displayed. The script is executed when the post is accessed by a visitor. The script then sends social media data back to the system from storage in a database. In one embodiment that transmitted social media data includes a date/time stamp; Blog URL, Influencer ID and IP address of the visitor.

The use of the system generated identifier also ensured that the influencer performs as agreed in his engagement contract with the advertiser. The system tracks the number of posts the influencer publishes for a given influencer campaign. Any posts that do not contain the identifier are not recorded and are not used to calculate the influencer's performance, for a given influencer campaign. Also as discussed below, if the influencer reports posts that are not tracked by the system, the advertiser may withhold compensation to the influencer. This helps ensure that the influencer performs as agreed.

Social media data such Social Reach and/or Social Engagement data may include such. Information as bow often the information is viewed, whether the information has been shared by the consumer, whether a consumer has posted comments about the information and the like. All of this information is gathered and stored in a campaign database. The data can then be analyzed and reports created to show how effective the campaign has been, 106.

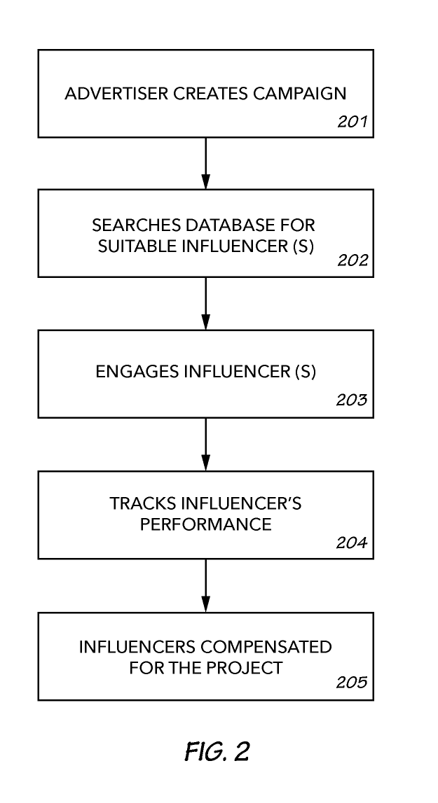

FIG. 2 shows the steps used by an advertiser to implement a campaign using the system of the invention. In step 201, the advertiser logs in to the system and enters the details of the campaign he wishes to initiate including, but not limited to the specific information the influencer is to convey to potential consumers, pictures and graphics that may be included in the influencer's posts, which forms blogs or social media should be used, brand guidelines and the type of influencer that the advertiser is interested in using for the campaign. FIGS. 4 and 5 show an example of the type of information an advertiser can use to outline his influencer campaign, and generate a list of potential influencers.

In the next step 202, the system generates a list of potential influencers based on the criteria supplied by the advertiser. Included in the listing is a rating of the influencer discussed above. In one embodiment, influencers are assigned to one of a series of tiers representing the reach of the influencer. For example, one tier includes influencers who reach from 10,000 to 20,000 consumers on a monthly basis, and another tier includes influencers that reach between 20,000 and 80,000 consumers. A third tier represents influencers who reach over 80,000 consumers.

The Influencer listing may also include such information as the influencer's profile, blog and social media metrics which can be displayed graphically or through a third party interface, links to their social assets, influencer description and demographic details.

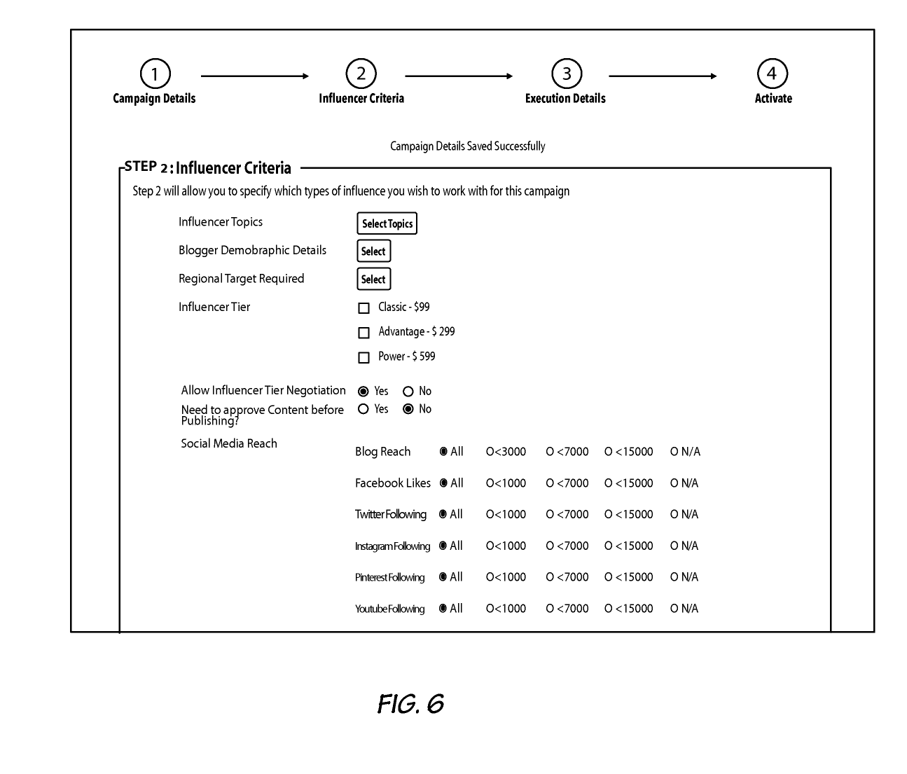

The advertiser then selects one or more influencers, 203, that he wants to use as part of the campaign. Using the system, the advertiser transmits an offer to the influencer soliciting the influencer's participation in the defined campaign. FIG 6 is an example of an offer generation screen used by the system. The offer contains such information as the information to be distributed by the influencer and the duration of the campaign. If the terms of the offer are acceptable to the influencer, the influencer sends the advertiser an acceptance and the campaign commences.

Once the campaign commences the advertiser can track the performance of individual influencers working on the campaign as well as the success of the campaign overall, 204. In one embodiment, the influencer places a badge or icon hi their posts relating to the campaign. The badge or icon is unique to the influencer and the campaign. In another embodiment, embedded within the badge is a link that facilitates the system's ability to track such social media data and Reach and Social Engagement information including but not limited to the number of blog posts, unique views and total views for each post created by the influencer as part of the campaign. In another embodiment, the badge or icon, also transmits the social media data it generates regarding the influencer's posts to a central database where the tracking information for each campaign is stored. The badge or icon can also serve as a Federal Trade Commission disclosure to ensure that influencers disclose that they are an ambassador for a specific brand or for a specific advertiser.

The system can be programed to update social media data on a periodic basis, typically once every 24 hours. This provides the advertiser with near real time data concerning the progress of their influencer campaign and ensures that the influencer rating is current.

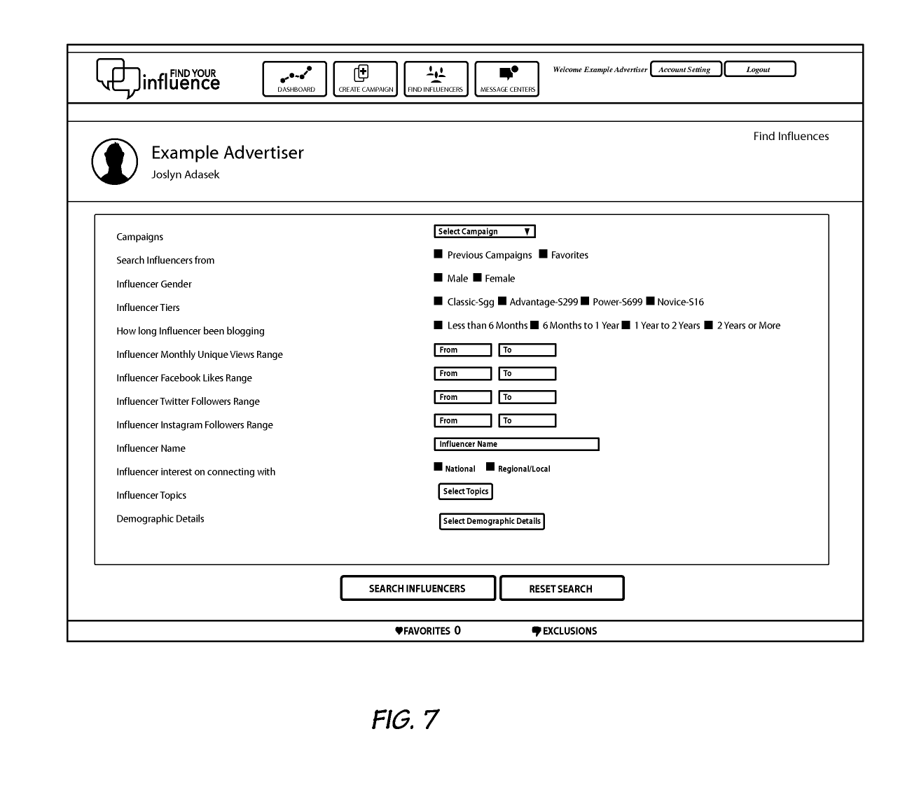

Upon receiving a request from the advertiser, the system can generate reports showing the effectiveness of each individual influencer as well as the campaign as a whole. As shown in FIG. 7 the system can generate reports showing overall social media data such as Social reach and Social Engagement data for difference social media as well as for specific influencers. For example, for the campaign shown in FIG. 7 the system has recorded 150 total tweets, 701, 85 retweets, 702, with an estimated reach of 2.98 million viewers, 703. As shown if FIG. 7, the reports can also contain data regarding the individual influencers used hi the campaign. The reports generated by the system can be displayed on a screen as shown on FIG 7; transmitted to the advertiser via email or other communication method or printed using a printer.

At the conclusion of the campaign, the influencer prepares and submits a report detailing his activities during the campaign. The reports are transmitted by the system to the advertiser. Upon receipt of the reports, the advertiser compares the reports to the campaign agreement and the tracking data contained in the tracking database. If the report and data meet the criteria agree to by the advertiser and the influencer, the advertiser submits payments for the influencer's services through the system from transmittal to the influencer, 205. If the report and data do not conform with the requirements set for in the engagement agreement, the Advertiser can refuse to submit payment.

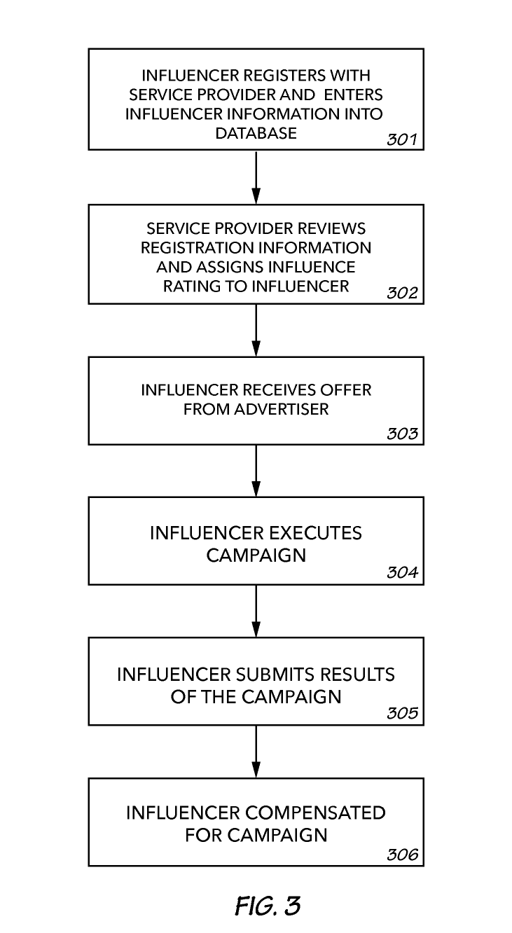

FIG. 3 shows how an influencer interacts with the system of the invention. The influencer first registers with the service provider providing sufficient information to enable advertisers to evaluate whether to engage the influencers services for a particular campaign, 301. In one embodiment the data includes demographic information such as sex and age, how long the influencer has been blogging, topics the influencer is interested in and the like. The information is then added to a database of potential influencers that can be searched by advertisers as described above.

The information is also used to rate the influencer in the manner described above, 302. The rating of each influencer is periodically updated to take into account changes in the influencer's ability to reach and influence consumers. This data is derived from the social media data collected by the system using the identifier assigned each campaign.

When an advertiser selects and influencer to participate in a specific campaign, the advertiser transmits an offer to the influencer as described above, 303. Upon receipt of an offer, the influencer can accept or reject the offer or can make a counter proposal to the advertiser. When the offer is accepted the influencer then commences to distribute the advertiser's information to consumers, 304.

Distribution of the information can be accomplished in a variety of forms including, but not limited to blogs, Facebook posts, tweets and the like. As discussed above, the influencer is provided an identifier that is unique to the influencer and the specific campaign. The influencer incorporates the identifier into his postings allowing the system to gather information regarding the effectiveness of his postings. In one embodiment, the identifier can be a badge or icon that also identifies the influencer and a Brand Ambassador satisfying Federal Trade Commission disclosure requirements.

At the conclusion of the campaign, the influencer submits a report of his activities to the advertiser through the system, 305. If the activity report matches the performance criteria agreed to by the advertiser and the influencer, the advertiser sends a payment for serviced to the influencer through the system, 306.

The system of the invention may also include a message center whereby advertisers and influences can communicate during the campaign. This helps ensure that the influencer is meeting the needs of the advertiser and that the advertiser keeps the influencer informed about any changes that might arise as the campaign proceeds.

The system of the invention comprises a database of potential influencers; a means for assigning each influencer an influence rating; a means for displaying a subset of influencers wherein the subset is created using criteria established by a user; a means for transmitting an offer from an advertiser to one or more influencers; and a means for tracking the performance of an influencer.

The system may also include a communication link, between the advertiser and the influencer; and a system for transmitting payments from the advertiser and the influencer.

Those skilled in the art will appreciate that the exemplary embodiments and descriptions are merely illustrative of the invention as a whole and that variations may be made within the spirit and scope of the invention.

What is claimed is:

1. A method for coordinating influencer campaigns comprising:
creating a database of potential influencers;
in response to a criteria set for by a user, generating a list of potential influencers;
transmitting an offer from, a user to an influencer for an influencer campaign;
tracking the performance of an influencer during the conduct of an influencer campaign;
generating reports regarding the effectiveness of an influencer campaign.

2. The method of claim 1 further comprising generating an identifier for inclusion in social media posts created by the influencer.

3. The method of claim 1 further comprising transmitting reports generated by an influencer to a user.

4. The method of claim 1 wherein tracking the performance of said influencer comprises:
generating an identifier for inclusion in social media posts by said influencer;
gathering social media data from said social media posts using said identifier;
generating an influencer rating using said social media data.

5. The method of claim 4 therein garnering social media data comprises:
searching social media for posts containing said identifier;
extracting said data from said posts.

6. The method of claim 4 further comprising displaying said influencer rating.

7. The method of claim 4 wherein said social media data comprises Social Reach and Social Engagement data

8. A method for evaluating the effectiveness of a influencer campaign comprising:
generating an identifier for inclusion in social media posts;
gathering social media data for posts containing said identifier;
storing said Social Reach data in a database;
and generating reports based on said social media data.

9. The method of claim 8 wherein social media data comprises Social Reach and Social Engagement data.

10. The method of claim 8 further comprising displaying said reports.

11. The method of claim 8 further comprising transmitting said reports to a user.

12. The method of claim 8 wherein said social media data comprises Social Reach and Social Engagement data.

13. A method for evaluating a social media influencer comprising;
generating an identifier for inclusion in social media posts generated by the influencer;
gathering social media data from said posts;
storing said data in a database; and
generating an influencer rating using said data.

14. The method of claim 13 further comprising searching social media sites for posts containing said identifier.

15. The method of claim 13 further comprising displaying the influencer rating.

16. The method of claim 13 wherein gathering social media data comprises:
connecting with a link embedded in said identifier;
extracting data associated with said link;
storing said social media data in a database.

17. The method of claim 13 wherein gathering social media data comprises:
searching social media sites for posts containing said identifier; and
extracting said data from said posts; and
storing said social media data in a database.
